(19) United States
(12) Patent Application Publication
(10) Pub. No.: US 2013/0028048 A1
(43) Pub. Date: Jan. 31, 2013

(54) METHODS AND APPARATUS FOR SEISMIC IMAGING WHICH ACCOUNTS FOR SEA-SURFACE VARIATIONS

(71) Applicant: Walter SÖLLNER, Oslo (NO)

(72) Inventor: Walter SÖLLNER, Oslo (NO)

(21) Appl. No.: 13/190,210

(22) Filed: Jul. 25, 2011

(51) Int. Cl. G01V 1/38

(52) U.S. Cl. 367/21

(57) ABSTRACT

Disclosed are apparatus and methods for seismic imaging which accounts for sea-surface variations. In accordance with one embodiment, a source wave-field is forward propagated to a subsurface level below a sea floor. In addition, a receiver wave-field is backward propagated to the subsurface level, wherein the backward propagation in time comprises synchronized backward running of the sea surface. Other embodiments, aspects, and features are also disclosed.

### BACKGROUND

In the oil and gas industry, geophysical prospecting is commonly used to aid in the search for and evaluation of subterranean formations. Geophysical prospecting techniques yield knowledge of the subsurface structure of the earth, which is useful for finding and extracting valuable mineral resources, particularly hydrocarbon deposits such as oil and natural gas. One technique of geophysical prospecting is a seismic survey. In a marine seismic survey, the seismic signal will first travel downwardly through a body of water overlying the subsurface of the earth.

Seismic energy sources (active seismic sources) are generally used to generate the seismic signal. Conventional energy sources for marine seismic surveys include air guns, water guns, marine vibrators, and other devices for generating acoustic wave-forms. After the seismic signal propagates away from the source, it is at least partially reflected by subsurface seismic reflectors of the earth body and by the sea surface (air-water contact). Such seismic reflectors are typically interfaces between subterranean formations having different elastic properties, specifically wave velocity and rock density, which lead to differences in acoustic impedance at the interfaces.

The reflections may be detected by marine seismic sensors (also called receivers) in an overlying body of water or alternatively on the sea floor. Conventional types of marine seismic sensors include particle-velocity sensors (geophones), water-pressure sensors (hydrophones), and other types of sensors. The resulting seismic data may be recorded and processed to yield information relating to the geologic structure and properties of the subterranean formations and their potential hydrocarbon content.

### BRIEF DESCRIPTION OF THE DRAWINGS

FIG. 1 is a cross-sectional view depicting wave-field sensors and a seismic source in accordance with an embodiment of the invention.

FIG. 2 is a plan view of the marine-towed wave-field sensors and a seismic source in accordance with an embodiment of the invention.

FIG. 3 is a flow chart showing a method for seismic imaging in accordance with an embodiment of the invention.

FIGS. 4A and 4B are flow charts showing methods of determining backward-propagated and forward-propagated wave-fields at an observation level in accordance with an embodiment of the invention.

FIGS. 5A and 5B are cross-sectional views depicting example ray paths originating from a seismic source in accordance with an embodiment of the invention.

FIG. 6 is a flow chart showing one method of determining time variation of a sea surface in accordance with an embodiment of the invention.

FIG. 7 is a flow chart showing one method of generating a seismic image which accounts for sea-surface variations in accordance with an embodiment of the invention.

FIG. 8 is a schematic diagram showing an example computer apparatus in accordance with an embodiment of the invention.

Note that the figures provided herewith are not necessarily to scale. They are provided for purposes of illustration to ease in the understanding of the presently-disclosed invention.

### DETAILED DESCRIPTION

The present disclosure provides methods and apparatus for marine seismic imaging in a way which accounts for the effects of sea-surface variations. These sea-surface variations are time-varying displacements of the sea surface relative to an idealized “flat” sea surface.

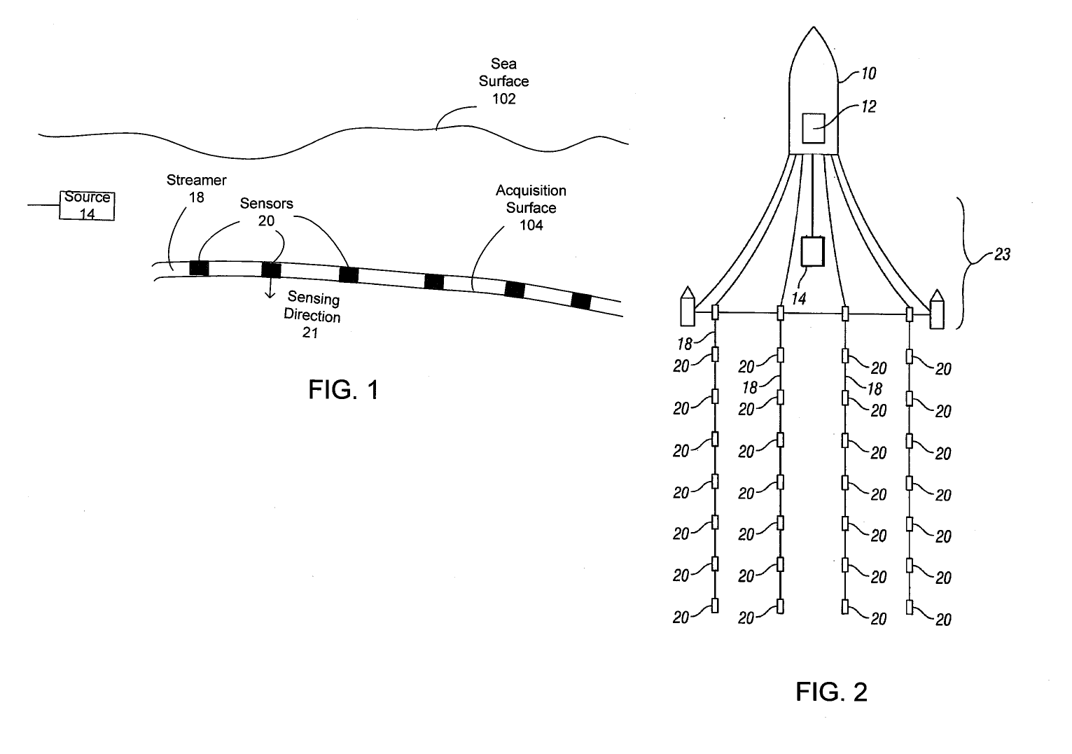

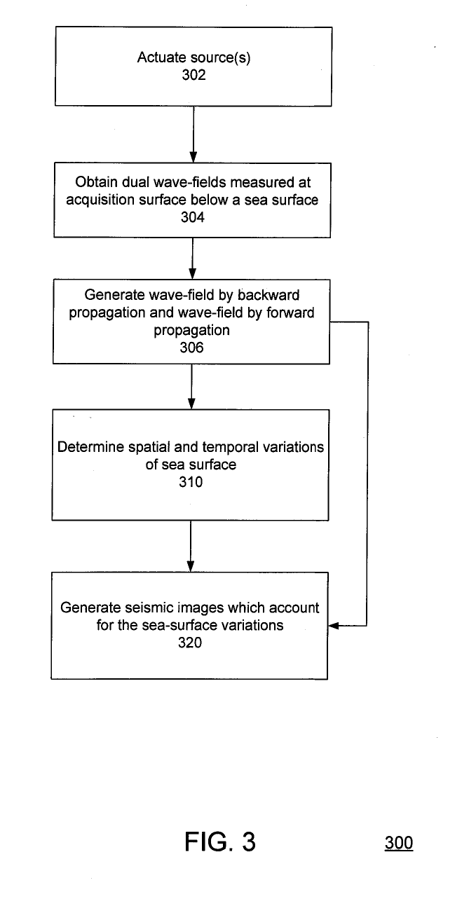

FIG. 1 is a cross-sectional view and FIG. 2 is a plan view of a marine-towed seismic (active) source 14 and marine-towed wave-field sensors 20 in accordance with an embodiment of the invention. While one active source is depicted in this embodiment, other embodiments may have two or more active sources. The seismic source(s) 14 may be above or below the acquisition surface 104. As shown in the plan view of FIG. 2, the seismic source 14 (or sources) may be towed behind the vessel.

As shown, a plurality of sensors 20 may be towed using a streamer 18. The sensors 20 may measure and record one or more wave-fields over time. An array of sensors 20 towed on multiple streamers 18 may define a smoothly-varying acquisition surface 104 below a sea surface 102. The smoothly-varying acquisition surface 104 is not necessarily flat and may, in fact, change shape over time due to weather conditions, variation of sea currents, and so forth.

In one embodiment, each sensor 20 in the array may be a dual sensor including two different types of sensors. The two different types of sensors may be co-located at discrete positions which may be regularly-spaced along each streamer 18. The sensing direction 21 of a directional sensor (such as a particle-velocity sensor, a particle-acceleration sensor, or a pressure-gradient sensor) may be in a direction normal to the acquisition surface 104 with, for example, the positive sign pointing down.

In one embodiment, a dual sensor may include a water-pressure sensor (hydrophone) and a particle-velocity sensor (geophone). In an alternate embodiment, a dual sensor may measure water pressure and particle acceleration. In another embodiment, the sensors may measure water pressure and a pressure gradient (or pressure derivative), for example, using a marine-towed over/under streamer. In other embodiments, other combinations of sensor types may be used.

As shown in FIG. 2, the streamers 18 may be maintained in their relative lateral and longitudinal positions with respect to the vessel 10 using towing equipment 23. It is contemplated that a wide variety of towing equipment may be employed, both currently available and to be developed. A data recording system 12 on the vessel may be used to record time-dependent signals obtained by the array of sensors 20 being towed by the vessel 10.

Since the streamers 18 are towed, the movement of the acquisition system in a fixed coordinate system is taken into account at acquisition site. Alternatively, instead of using moving receivers (towed streamers), stationary receivers may be used. The stationary receivers may be, for example, ocean bottom cables or nodes.

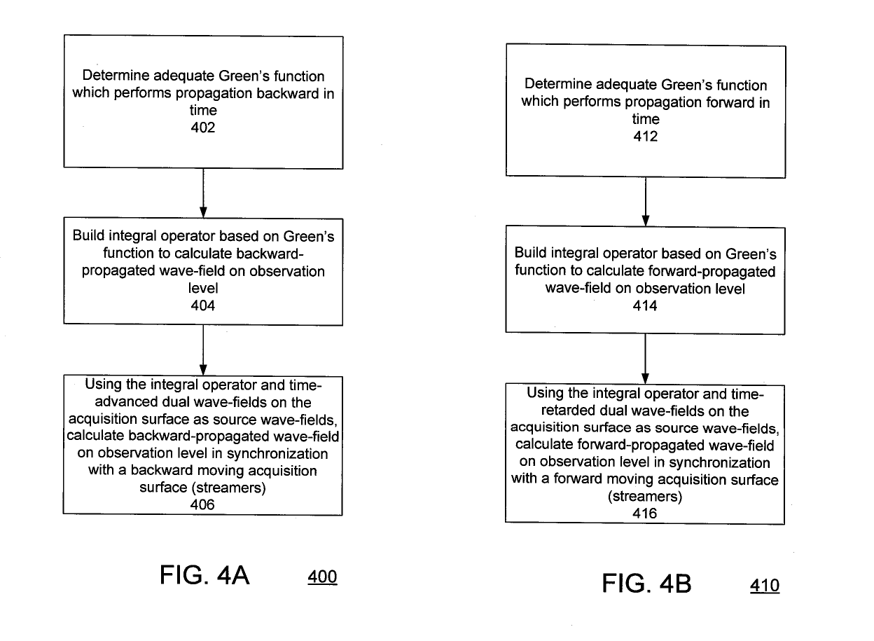

FIG. 3 is a flow chart showing a method for seismic imaging in accordance with an embodiment of the invention. The method 300 of FIG. 3 may be performed using a computer apparatus, and the seismic images generated by the method 300 may be, for example, printed on paper or displayed on a monitor of the computer apparatus.

The method 300 may begin by actuating 302 an “active” seismic source (or more than one active seismic sources). An active seismic source may be, for example, an air gun which generates a short-duration impulse by quickly releasing compressed air. Other types of seismic sources may also be used.

As shown, dual wave-fields may be obtained 304 by a computer. The dual wave-fields may be time-dependent wave-fields that are measured at an acquisition surface 104 below a sea surface 102. The measured wave-fields include subtle effects due to variations in the sea surface (rather than an idealized flat sea surface).

Dual wave-fields are two different wave-fields that may be measured at the same time by dual wave-field sensors. In one embodiment, one of the measured wave-field signals may be omnidirectional (without directional sensitivity, or, a scalar wavefield), and another of the measured wave-field signals may be directional (with a directional sensitivity, or, a vector wavefield). In one implementation, a first measured wave-field may be a pressure wave-field measured by hydrophones, and a second wave-field may be a particle-velocity wave-field measured by geophones. Other types of wave-fields may be measured in other implementations.

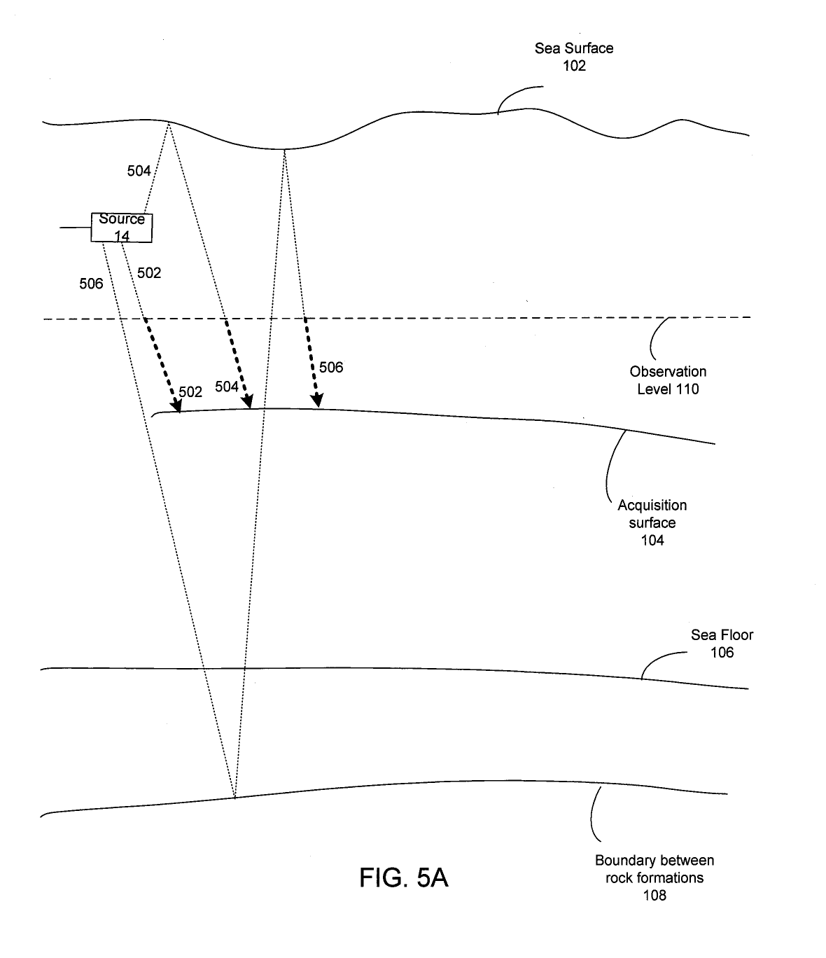

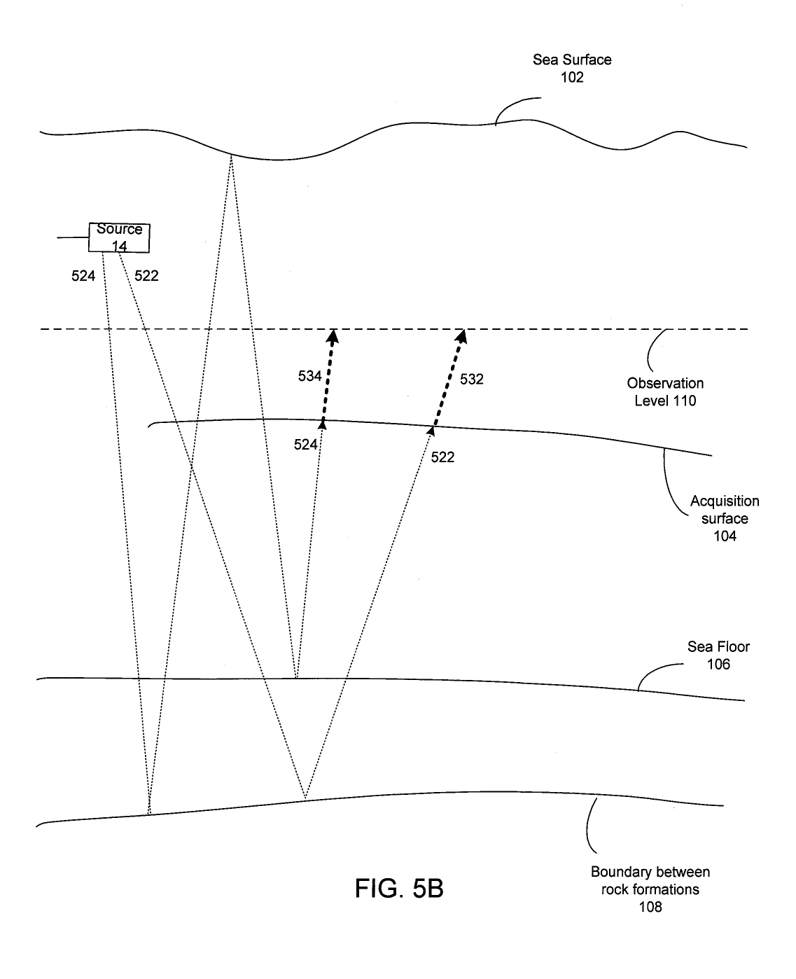

The computer may then generate 306 from the dual wave-fields, at a selected observation level above the acquisition surface, a wave-field by backward (inverse) propagation in time and a wave-field by forward propagation in time. For a flat observation level and homogeneous media between the acquisition surface and the observation level, the backward (inverse) propagated wave-field is of down-going energy and the forward propagated wave-field is of up-going energy. Such an observation level 110 is depicted, for example, in FIGS. 5A and 5B. One method 400 of determining the backward propagated and forward propagated wave-fields at the observation level is described below in relation to FIG. 4.

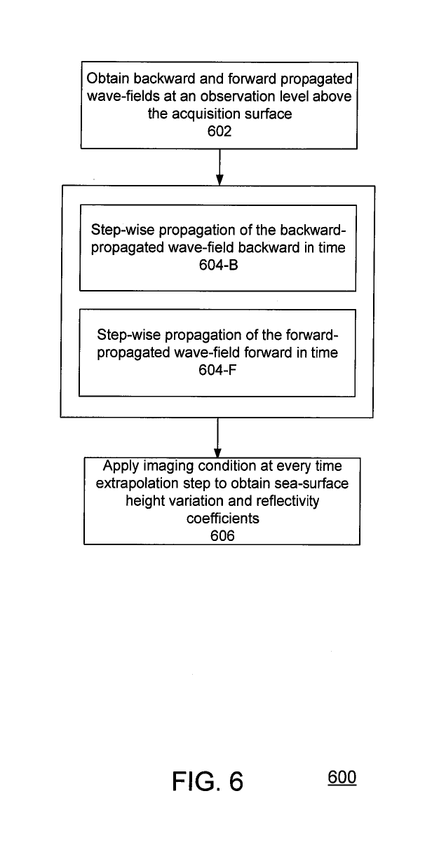

Using the backward and forward extrapolated wave-fields, the computer may determine 310 spatial and temporal variations of the sea surface. These sea-surface variations are time-varying displacements of the sea surface relative to an idealized “flat” sea surface. One method 600 of determining the sea-surface variations is described below in relation to FIG. 6.

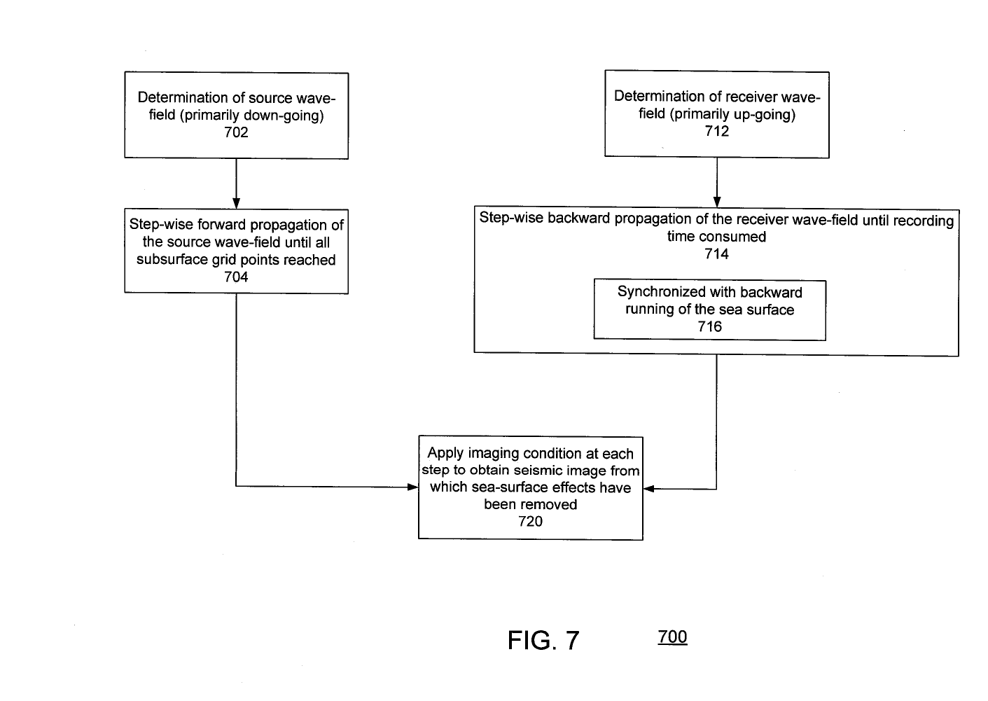

The method 300 then generates 320 seismic images which account for the sea-surface variations. In other words, the seismic images are generated in a way that removes the effects of the sea-surface variations. This step 320 uses both the wave-fields determined in step 306 and the sea-surface variations determined in step 310. One method 800 of generating the seismic images which account for sea-surface variations is described below in relation to FIG. 7.

FIG. 4A is a flow chart showing one method 400 of generating a backward propagated wave-field at an observation level in accordance with an embodiment of the invention. FIG. 4B is a flow chart showing one method 410 of generating a forward propagated wave-field at an observation level in accordance with an embodiment of the invention. Block 306 in FIG. 3 may be implemented, for example, using these methods 400 and 410. In other embodiments, alternative methods may be used to implement Block 306 in FIG. 3.

As shown in FIG. 4A, an adequate Green's function which performs backward propagation in time in a medium above the streamer may be determined 402 by a computer. Using the time-advanced dual wave-fields on the acquisition surface as source wave-fields, a first integral operator may be built 404 from this Green's function in order to calculate 406 backward-propagated wave-fields on the observation level. This step is synchronized with a backward moving streamer. The calculation may assume a homogeneous medium between the acquisition surface and the observation level. A physical realizable process of back propagation in time may be achieved after time reversal of the recorded dual wave-fields around a maximum recording time. Here, spatial and temporal reciprocity are assumed.

As shown in FIG. 4B, an adequate Green's function which performs forward propagation in time in a medium above the streamer may be determined 412 by a computer. Using the time-retarded dual wave-fields on the acquisition surface as source wave-fields, a second integral operator may be built 414 from this Green's function in order to calculate 416 forward-propagated wave-fields on the observation level. This step is synchronized with a forward moving streamer. The calculation may assume a homogeneous medium between the acquisition surface and the observation level.

FIGS. 5A and 5B are cross-sectional views depicting example ray paths originating from a seismic source in accordance with an embodiment of the invention. A few example ray paths are depicted for illustrative purposes.

FIG. 5A is a cross-sectional view showing three example ray paths (502, 504 and 506) starting at the source 14 and ending at the acquisition surface 104 in accordance with an embodiment of the invention. These ray paths shown are merely a few example ray paths for purposes of illustration.

The first example ray path 502 depicts the path of a wave-field component which travels directly from the seismic source 14 to the acquisition surface 104. The second example ray path 504 depicts the path of a wave-field component which originates from the seismic source 14 and is singly reflected by the sea surface 102. The third example ray path 506 depicts the path of a wave-field component which starts at the source, is first reflected at a subsurface reflector (boundary 108) and is secondly reflected at the sea surface 102 (including the effect of pressure changes caused by the sea surface variations).

Backward propagation travels backward in time such that the emphasized (heavier, dashed portions) of the ray paths are effectively “removed”. In other words, the backward propagation effectively brings those wave-field components back to the time when they arrived at the observation level 110 (which was before they reached the acquisition surface 104).

For homogeneous medium between the acquisition surface and the observation level, the backward-propagated wave-field at the observation level represents the totality of all such down-going wave-field components. More generally, the backward-propagated wave-field may also contain, besides the down-going wave-field components, up-going wave-field components.

FIG. 5B is a cross-sectional view showing two example ray paths (522 and 524) starting at the source 14 and ending at the acquisition surface 104 in accordance with an embodiment of the invention. These ray paths shown are merely a few example ray paths for purposes of illustration.

The first example ray path 522 depicts the path of a wave-field component which originates from the seismic source 14 and is singly reflected by a subsurface reflector (boundary 108). The second example ray path 524 depicts the path of a wave-field component which starts at the seismic source 14, is first reflected at a subsurface reflector (boundary 108), is secondly reflected at the sea surface 102 (including the effect of sea surface variations), and is thirdly reflected at the sea floor 106.

Forward propagation travels forward in time such that the emphasized (heavier, dashed portions) ray paths 522 and 524 are effectively “extended” by the additional path segments 532 and 534, respectively. In other words, the forward propagation effectively brings those wave-field components ahead to the time when they are to arrive at the observation level 110 (which was after they reached the acquisition surface 104).

For a homogeneous medium between the acquisition surface and the observation level, the forward-propagated wave-field at the observation level represents the totality of all such up-going wave-field components. More generally, the forward-propagated wave-field may also contain, besides the up-going wave-field components, down-going wave-field components.

As described herein, the combination of the backward-propagated wave-field and the forward-propagated wave-field allows for the extraction of the subsurface reflectivity function. This is because, in accordance with an embodiment of the invention, at any depth point below the sea surface, the backward-propagated “receiver” wave-field in time may be considered to be the subsurface reflectivity convolved with the forward-propagated “source” wave-field in time. As such, the subsurface reflectivity function at a specific depth level may be extracted by deconvolution of the source and receiver wave-fields at that depth level.

FIG. 6 is a flow chart showing one method 600 to determine sea-surface variations in accordance with an embodiment of the invention. Block 310 in FIG. 3 may be implemented using this method 600.

Backward propagated and forward propagated wave-fields at a selected observation level are obtained 602. Subsequently, step-wise backward and forward propagation in time may be performed (604-B and 604-F, respectively) to determine the wave-fields at progressively shallower depth grid points in a medium of known acoustic parameters (but unknown water-air interface) above the acquisition surface. In particular, to determine the backward propagated and forward propagated wave-fields at a particular depth grid point above the observation level (i.e. at a particular grid point at a depth above the observation level), the procedure 400 may be repeated using adequate integral operators for the step-wise propagation 604-B backward in time, and the procedure 410 may be repeated using adequate integral operators for the stepwise propagation 604-F forward in time to the particular depth grid point.

At every grid point of the sea surface to be calculated, an imaging condition may be applied 606 to the forward and backward propagated wave-fields so as to obtain an image of the sea-surface height and reflectivity coefficients. For example, zero-lag cross-correlation values may be determined from a sequence of time steps, and the height of a horizontal location (image point) on the sea surface may be the position (at that time step) with a maximum zero-lag cross-correlation value. For time varying sea surfaces, more than one image point (multiple maxima at the same grid point) are possible. The reflection coefficient may be determined by dividing the backward-propagated wave-field in time by the forward propagated wave-field in time at the sea surface image point. An example of a similar computation is described in commonly-owned U.S. Pat. No. 7,872,942, issued Jan. 18, 2011, the disclosure of which is hereby incorporated by reference. Other computational techniques may also be employed.

FIG. 7 is a flow chart showing one method 700 of generating a seismic image which accounts for sea-surface variations in accordance with an embodiment of the invention. Block 320 in FIG. 3 may be implemented using this method 700.

As shown in FIG. 7, the source wave-field may be determined 702. As the depth of interest is generally below the acquisition surface, the source wave-field may include only down-going wave-fields at the source depth level. Methods and apparatus for determining this source wave-field are known in the art. As a consequence, it may be assumed that up-going wave-field components at the source level are not existent in the acquired data. Subsequently, step-wise forward propagation in time may be performed 704 to determine the propagated source wave-field at progressively lower depth levels. In particular, to determine the forward-propagated source wave-field at a particular depth grid point below the sea surface level, the source wave-field may be propagated step-wise forward in time in a model of known elastic parameters down to the particular depth grid point. The forward propagation 704 of the sea-surface wave-field may be continued incrementally until all the subsurface grid points are reached.

As further shown in FIG. 7, the receiver wavefield may be determined 712 and step-wise backward (reverse) propagation in time of the receiver wave-field may be performed 714 to determine the receiver wave-field at progressively earlier times and lower depth levels until the recording time is consumed. As the depth level of interest is generally below the acquisition surface, the receiver wave-field may include primarily, but not exclusively, up-going wave-fields. In particular, to determine the backward propagated wave-field at a particular depth level below the observation level, the receiver wave-field is propagated step-wise backward in time in a model of known elastic parameters down to the particular depth level, while the sea surface is running synchronously backward in time. The synchronized backward running of the sea surface 716 is needed in order to assure temporal reciprocity.

Returning to FIG. 7, once the two wave-fields (source and receiver) have each been propagated, an imaging condition may be applied 720 at time coincidence (i.e. the ignition time of the receiver wave-field) at desired grid points to obtain a seismic image from which sea-surface effects have been removed. For example, deconvolution of the wave-fields may be performed to obtain a subsurface reflectivity function at the desired depth grid points.

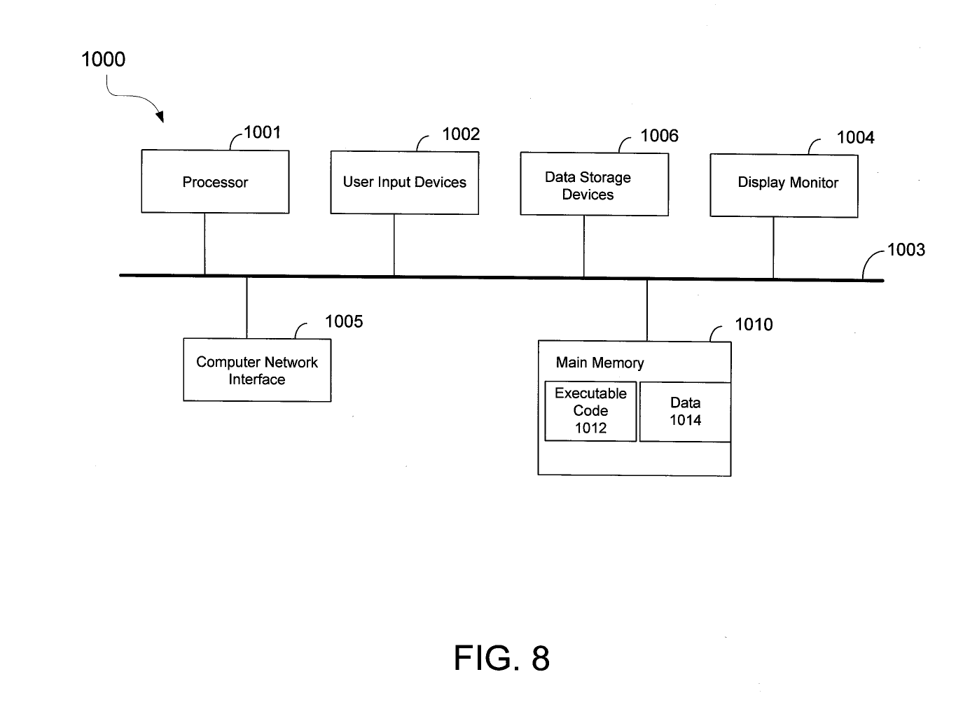

FIG. 8 is a schematic diagram showing a computer apparatus 1000 in accordance with an embodiment of the invention. The computer apparatus 1000 may be configured with executable instructions so as to perform the data processing methods described herein. This figure shows just one example of a computer which may be used to perform the data processing methods described herein. Many other types of computers may also be employed, such as multi-processor computers, server computers, cloud computing via a computer network, and so forth.

The computer apparatus 1000 may include a processor 1001, such as those from the Intel Corporation of Santa Clara, Calif., for example. The computer apparatus 1000 may have one or more buses 1003 communicatively interconnecting its various components. The computer apparatus 1000 may include one or more user input devices 1002 (e.g., keyboard, mouse), one or more data storage devices 1006 (e.g., hard drive, optical disk, USB memory), a display monitor 1004 (e.g., LCD, flat panel monitor, CRT), a computer network interface 1005 (e.g., network adapter, modem), and a main memory 1010 (e.g., RAM).

In the example shown in this figure, the main memory 1010 includes executable code 1012 and data 1014. The executable code 1012 may comprise computer-readable program code (i.e., software) components which may be loaded from the data storage device 1006 to the main memory 1010 for execution by the processor 1001. In particular, the executable code 1012 may be configured to perform the data processing methods described herein.

In the above description, numerous specific details are given to provide a thorough understanding of embodiments of the invention. However, the above description of illustrated embodiments of the invention is not intended to be exhaustive or to limit the invention to the precise forms disclosed. One skilled in the relevant art will recognize that the invention can be practiced without one or more of the specific details, or with other methods, components, etc. In other instances, well-known structures or operations are not shown or described in detail to avoid obscuring aspects of the invention. While specific embodiments of, and examples for, the invention are described herein for illustrative purposes, various equivalent modifications are possible within the scope of the invention, as those skilled in the relevant art will recognize.

These modifications can be made to the invention in light of the above detailed description. The terms used in the following claims should not be construed to limit the invention to the specific embodiments disclosed in the specification and the claims. Rather, the scope of the invention is to be determined by the following claims, which are to be construed in accordance with established doctrines of claim interpretation.

What is claimed is:

1. A method for seismic imaging which accounts for sea-surface variations, the method comprising:
forward propagation, by computer, of a source wave-field to a subsurface level below a sea floor;
backward propagation, by computer, of a receiver wave-field to the subsurface level, wherein the backward propagation comprises synchronized backward running of the sea surface; and
applying, by computer, an imaging condition to the source and receiver wave-fields at the subsurface level to generate a seismic image.

2. The method of claim 1 further comprising determining time variation of the sea surface.

3. The method of claim 2, wherein determining the time variation of the sea surface comprises:
determining backward and forward propagated wave-fields at an observation level;
step-wise backward propagation of the backward propagated wave-field;
step-wise forward propagation of the forward propagated wave-field; and
applying an imaging condition at each time extrapolation step to obtain the time variation of the sea surface.

4. The method of claim 3, wherein applying the imaging condition at every time extrapolation step comprises determining a maximum zero-lag cross-correlation to determine a height of an image point on the sea surface.

5. The method of claim 4, wherein applying the imaging condition at every time extrapolation step further comprises dividing the backward-propagated wave-field by the forward-propagated wave-field to obtain a reflection coefficient.

6. The method of claim 1, further comprising:
obtaining dual wave-fields measured at an acquisition surface; and
generating the source and receiver wave-fields from the dual wave-fields.

7. An apparatus configured to generate seismic images, the apparatus comprising:
memory configured to store processor-executable code and data;
a processor configured to execute the processor-executable code so as to modify the data;
processor-executable code configured to perform forward propagation of a source wave-field to a subsurface level below a sea floor;
processor-executable code configured to perform backward propagation of a receiver wave-field to the subsurface level, wherein the backward propagation comprises synchronized backward running of the sea surface; and
processor-executable code configured to apply an imaging condition to the source and receiver wave-fields at the subsurface level to generate a seismic image.

8. The apparatus of claim 7 further comprising:
processor-executable code configured to determine time variation of the sea surface.

9. The apparatus of claim 8, wherein the processor-executable code configured to determine time variation of the sea surface comprises:
processor-executable code configured to determine backward and forward propagated wave-fields at an observation level;
processor-executable code configured to perform step-wise backward propagation of the backward propagated wave-field;
processor-executable code configured to perform step-wise forward propagation of the forward propagated wave-field; and
processor-executable code configured to apply an imaging condition at each time extrapolation step to obtain the time variation of the sea surface.

10. The apparatus of claim 9, wherein the processor-executable code configured to apply an imaging condition at each time extrapolation step comprises processor-executable code configured to determine a maximum zero-lag cross-correlation to find a height of an image point on the sea surface.

11. The apparatus of claim 10, wherein the processor-executable code configured to apply an imaging condition at every time extrapolation step further comprises processor-executable code configured to divide the backward-propagated wave-field by the forward-propagated wave-field to obtain a reflection coefficient.

12. The apparatus of claim 7, further comprising:
marine seismic sensors configured to obtain dual wave-fields measured at an acquisition surface; and
processor-executable code configured to generate the source and receiver wave-fields from the dual wave-fields.

13. A marine seismic imaging system comprising:
marine seismic wave-field acquisition apparatus configured to measure and record dual wave-field data; and
data processing apparatus configured to generate seismic images from the dual wave-field data, the data processing apparatus including
memory configured to store processor-executable code and data,
a processor configured to execute the processor-executable code so as to modify the data,
processor-executable code configured to perform forward propagation of a source wave-field to a subsurface level below a sea floor;
processor-executable code configured to perform backward propagation of a receiver wave-field to the subsurface level, wherein the backward propagation comprises synchronized backward running of the sea surface and synchronized backward running of the acquisition surface; and
processor-executable code configured to apply an imaging condition to the source and receiver wave-fields at the subsurface level to generate a seismic image.

14. The system of claim 13, further comprising:
processor-executable code configured to determine time variation of the sea surface.

15. The system of claim 14, wherein the processor-executable code configured to determine time variation of the sea surface comprises:
processor-executable code configured to determine backward and forward propagated wave-fields at an observation level;
processor-executable code configured to perform step-wise backward propagation of the backward propagated wave-field;
processor-executable code configured to perform step-wise forward propagation of the forward propagated wave-field; and
processor-executable code configured to apply an imaging condition at each time extrapolation step to obtain the time variation of the sea surface.

16. At least one tangible computer-readable storage medium with executable code stored thereon which, when executed by one or more processors, performs steps comprising:
forward propagation of a source wave-field to a subsurface level below a sea floor;
backward propagation of a receiver wave-field to the subsurface level, wherein the backward propagation comprises synchronized backward running of the sea surface; and
applying an imaging condition to the source and receiver wave-fields at the subsurface level to generate a seismic image.

17. The at least one tangible computer-readable storage medium of claim 16, wherein the steps further comprise:
determining time variation of the sea surface.

18. The at least one tangible computer-readable storage medium of claim 16, wherein determining the time variation of the sea surface comprises:
determining backward and forward propagated wave-fields at an observation level;
step-wise backward propagation of the backward propagated wave-field;
step-wise forward propagation of the forward propagated wave-field; and
applying an imaging condition at each time extrapolation step to obtain the time variation of the sea surface.
